(19) United States
(12) Patent Application Publication
(10) Pub. No.: US 2026/0018001 A1
(43) Pub. Date: Jan. 15, 2026

(54) SYSTEMS AND METHODS FOR PROVIDING A RENTAL CANDIDATE WITH ACCESS TO A RENTAL ASSET

(71) Applicant: Wells Fargo Bank, N.A., San Francisco, CA (US)

(72) Inventors: Young M. Yang, San Francisco, CA (US); Michelle W. Chan, San Francisco, CA (US); Robin H. Lo, San Francisco, CA (US); Tiffany N. Twilley, Foster City, CA (US)

(21) Appl. No.: 18/771,976

(22) Filed: Jul. 12, 2024

(51) Int. Cl. G07C 9/20; G06F 21/31

(52) U.S. Cl. CPC G07C 9/20; G06F 21/31

(57) ABSTRACT

Systems, apparatuses, methods, and computer program products are disclosed for providing a rental candidate with access to a rental asset. An example method includes receiving, from a candidate device, a rental initiation request comprising (a) an indication of the rental asset, (b) an indication of a mDL associated with the rental candidate, and (c) rental candidate information. The example method further includes authenticating the rental candidate based on the mDL. The example method further includes determining, using a risk determination model, a risk level indicative of an inferred risk associated with renting the rental asset to the rental candidate. The example method further includes, in response to the risk level satisfying a rental requirement, generating a rental access key configured to enable use of the rental asset, and providing the rental access key to the candidate device.

### BACKGROUND

Rental entities require rental candidates to provide sensitive personal information (e.g., credit scores, proof of income, employment history, rental history, etc.) for assessment of reliability and financial stability before providing access to a rental asset. However, conventional rental asset provision systems and techniques exhibit numerous drawbacks, inefficiencies, and limitations.

### BRIEF SUMMARY

Conventional rental asset provision systems, such as those provided by rental entities, operate by manually gathering and analyzing various elements of personal and financial information associated with a rental candidate. The process of verifying the identity of the rental candidate is crucial for minimizing the risk associated with providing the rental candidate with access to the rental asset. However, current rental asset provision systems typically rely on manual processes, which may be time-consuming and error prone. For instance, collecting and verifying information such as proof of identity (e.g., physical driver's license), income, employment history, payment method, and rental references heavily involve numerous steps and coordination with various third parties. This manual effort often requires recurring interactions with the rental entity, which may lead to delays, increased administrative workload, and the potential for human error in data entry or evaluation. Moreover, inconsistencies in how rental candidate information is collected and interpreted may also result in subjective decision making, which may affect the fairness and accuracy of the rental asset provision process.

Additionally, the manual handling of rental candidate information introduces significant privacy concerns. When rental candidates provide sensitive personal information, such as social security numbers, date of birth, financial records, employment details, and/or the like, there exists an inherent risk of data breaches and misuse. Service providers may misplace such materials, copy them, and for various reasons may expose them visibly to individuals who do not have authority to view such content. Existing processes that rely on physical document exchange present a substantial risk of unauthorized access or data leaks. In particular, the manual handing of rental candidate information may lead to unauthorized access and/or exposure, which not only compromises the security of the rental candidate's personal information, but also exposes rental entities to potential legal liabilities and damage to their reputations. Evidently, ensuring robust data protection measures and adoption of a more secure, automated rental asset provision process has become imperative. Underpinning this need is a failure of existing technology to offer solutions that remove the physical exchange of materials from the rental asset provision process. As such, there is a unique need for a technical solution that automates and streamlines the rental asset provision process by minimizing the manual provision of rental assets to rental candidates. Given that provision of rental assets often must occur in near-real-time and in many parallel instances at scale, especially to meet time-sensitive rental evaluation deadlines, a systematic and computer-based implementation is necessary to mitigate delays and risks associated with the manual provision of rental assets. In other words, there exists an underlying technical necessity for rental asset provision systems that are able to autonomously provide this capability.

Example implementations described herein provide a technical solution to this technical problem, and in doing so overcome the challenges that arise from the manual provision of rental assets during a rental event. In contrast to conventional techniques for providing a rental candidate with access to a rental asset, example embodiments described herein comprise a rental asset provision system 102 configured to authenticate a mobile driver's license (mDL) associated with a rental candidate to verify the identity of the rental candidate, and in response to the authentication of the mDL, generate a rental access key that enables the rental candidate to secure access to the rental asset. The rental asset provision system 102 may be employed to remotely authenticate the rental candidate based on a respective mDL associated with the rental candidate. As will be described in greater detail below, utilizing mDLs that have been issued by legally entitled entities (e.g., government agencies) adds an additional layer of trust to each rental event facilitated by the rental asset provision system 102. Furthermore, utilizing mDLs to authenticate and/or verify rental candidates ensures that only intended parties are receiving information associated with a particular rental event and a particular rental candidate. The solutions described herein therefore operate in a wholly new fashion that is distinct from existing approaches (i.e., they do not comprise the mere automation of previously manual activity, but instead set forth an entirely new sequence of operations unlocked via use of an mDL within a computer-implemented infrastructure).

Additionally, example implementations described herein are not limited solely to traditional rental events (e.g., renting a property, renting a car) involving a tangible rental candidate item, and may also be extended to non-tangible rental candidate items such as software as a service (SaaS), virtual private networks (VPNs), online courses and educational content, and/or the like for whom verification and/or authentication is required. In such instances, the example embodiments described herein facilitate the seamless provision of a rental asset whilst eliminating the need for manual documentation for identity verification. This versatile feature underscores the applicability of the technical solution across diverse rental event contexts, thereby enhancing its utility and value proposition in various operational settings.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for providing a rental candidate with access to a rental asset.

FIG. 2 illustrates a schematic block diagram of example circuitry embodying a system device that may perform various operations in accordance with some example embodiments described herein.

FIG. 3 illustrates an example flowchart for providing a rental candidate with access to a rental asset, in accordance with some example embodiments described herein.

FIG. 4 illustrates an example flowchart for authenticating, based on the rental initiation request, the mDL associated with the rental candidate, in accordance with some example embodiments described herein.

FIG. 5 illustrates an example flowchart for determining, using a risk determination model, a risk level indicative of an inferred risk associated with renting the rental asset to the rental candidate, wherein the risk level is determined based on the rental asset and the rental candidate information, in accordance with some example embodiments described herein.

FIG. 6 illustrates an example flowchart for providing the secondary rental access key to the secondary candidate device, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

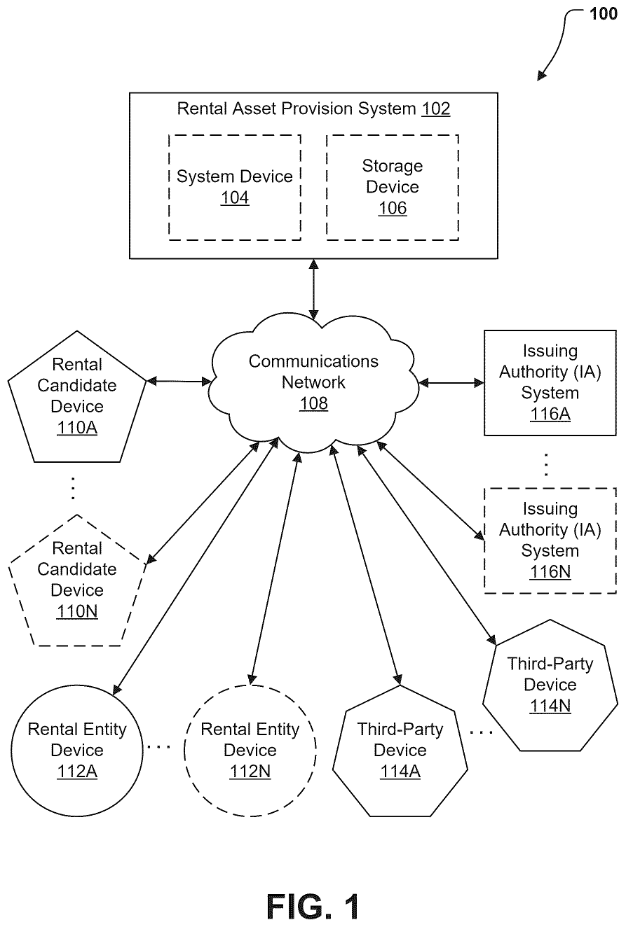

Example embodiments described herein may be implemented using any of a variety of computing devices or servers. To this end, FIG. 1 illustrates an example environment 100 within which various embodiments may operate. As illustrated, a rental asset provision system 102 may receive and/or transmit information via communications network 108 (e.g., the Internet) with any number of other computing devices and/or computing systems, such as one or more of rental candidate devices 110A-110N, rental entity devices 112A-112N, third-party devices 114A-114N, and/or issuing authority (IA) systems 116A-116N. Although system device 104 and storage device 106 are described in singular form, some embodiments may utilize more than one system device 104, more than one storage device 106, and/or the like. The one or more rental candidate devices 110A-110N, rental entity devices 112A-112N, and/or third-party devices 114A-114N, may be embodied by any computing devices known in the art. The one or more rental candidate devices 110A-110N, rental entity devices 112A-112N, and/or third-party devices 114A-114N need not themselves be independent devices but may be peripheral devices communicatively coupled to other computing devices. The one or more rental candidate devices 110A-110N may include laptops, tablets, phones, whereas the one or more rental entity devices 112A-112N and/or third-party devices 114A-114N may be a device associated with a rental entity and/or a third party that performs operations related to provision of the rental asset.

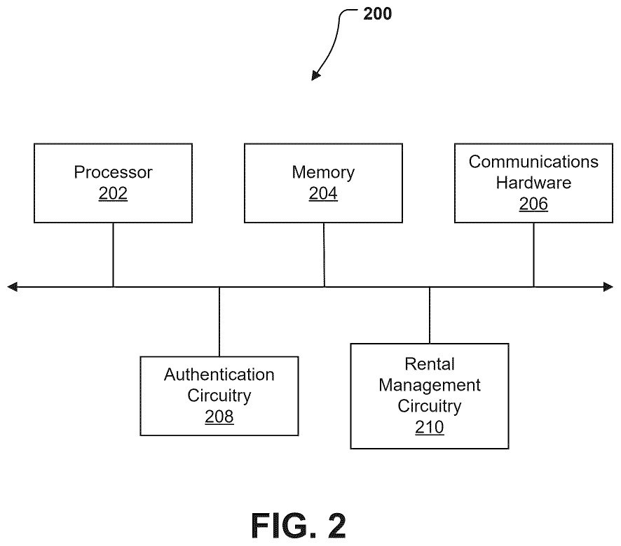

The rental asset provision system 102 may be implemented as one or more computing devices or servers, which may be composed of a series of components. These components of system device 104 may be physically proximate to the other components of the rental asset provision system 102, while other components are not. The system device 104 may receive, process, generate, and transmit data, signals, and electronic information to facilitate the operations of the rental asset provision system 102. Particular components of the rental asset provision system 102 are described in greater detail below with reference to apparatus 200 in connection with FIG. 2.

In some embodiments, the rental asset provision system 102 further comprises and/or integrates with a storage device that comprises a distinct component from other components of the rental asset provision system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Additionally, or alternatively, the storage device may host the software executed to operate the rental asset provision system 102. Additionally or alternatively, the storage device may store information relied upon during operation of the rental asset provision system 102, such as various rental candidate data (e.g., rental candidate information), mDL data (e.g., cryptographical information, credential information), rental entity data (e.g., payment account data, rental candidate transaction data, product and/or service data), smart mobile wallet data (e.g., payment account data, payment card data, and/or the like associated with a rental candidate), distribution data, logistical data, legal data, software application framework data, etc.), and/or the like configured in various data formats to be utilized by the rental asset provision system 102. In addition, the storage device may store control signals, device characteristics, and/or access credentials enabling interaction between the rental asset provision system 102 and/or one or more of the rental candidate devices 110A-110N, rental entity devices 112A-112N, and/or third-party devices 114A-114N.

In some embodiments, the rental asset provision system 102 may be configured to facilitate the execution of one or more processes related to authenticating a rental candidate based on an mDL associated with the rental candidate. As a non-limiting example, the rental asset provision system 102 may be configured to authenticate a respective mDL associated with the rental candidate to verify the identity of the rental candidate prior to providing the rental candidate with access to a rental asset. In this regard, the rental asset provision system 102 may be configured to store, integrate with, manage, and/or utilize one or more mDLs (and/or data related to the one or more mDLs (e.g., mDL identifying information, cryptographic key information) associated with a rental candidate in order to facilitate the various operations described herein. As used herein, the term “mDL” covers various mobile (e.g., digital) identity credential types associated with a rental candidate including mobile driver's licenses and mobile identification cards. An mDL may be an electronically managed data structure configured to be accessed, processed, and/or otherwise utilized by the rental asset provision system 102 for various authentication processes.

In this regard, an mDL may be configured to store or point to (e.g., programmatically reference) various credential data associated with a rental candidate including, but not limited to, personally identifiable information (PII) (e.g., given name, family name, name prefix, name suffix, driver's license number, social security number, administrative number), rental candidate information (e.g., height, eye color, hair color, age, organ donor status, veteran status, gender information, sex information, race information, ethnicity information, rental candidate portrait image data, rental candidate signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data), credential restriction data (e.g., driving restrictions, driving conditions, vehicle weight class restrictions), and/or the like associated with the rental candidate. Additionally, an mDL may be configured to store and/or point to various cryptographic key information (e.g., public key information used to identify the mDL, a corresponding rental candidate device, and/or a corresponding rental candidate) and/or originating IA data (e.g., cryptographic key information and/or identifying data associated with an originating IA).

An mDL may be issued (e.g., provisioned) to a rental candidate by an IA system 116A associated with a particular IA. An IA may be an entity that is legally entitled (or otherwise recognized as the relevant authority) to issue credentials, such as driver's licenses and/or other identification cards. An IA system 116A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 116A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the rental asset provision system 102 in compliance with various standards set forth by the American Association of Motor Vehicle Administrators (AAMVA).

Additionally, or alternatively, in some embodiments, an mDL may be administered, managed, employed, and/or otherwise utilized by the rental asset provision system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a rental candidate and may comprise and/or be associated with the same data as the legal credential. In some embodiments, an mDL associated with a rental candidate may be stored in a storage device (e.g., a server system) of an IA system 116A and one or more portions of credential data related to the mDL may be retrieved in real time, or near-real time, during a transaction associated with the rental candidate (e.g., an online transaction requiring rental candidate verification, rental candidate authentication, rental candidate age verification, and/or the like). Additionally, or alternatively, once an mDL is issued to a rental candidate by a respective IA (e.g., by way of a corresponding IA system 116A), the mDL may be stored locally on a rental candidate device associated with the rental candidate (e.g., rental candidate device 110A) such that the mDL may be used without relying on a communications network (e.g., communications network 108). Additionally, or alternatively, in some embodiments, an mDL may be stored in a smart mobile wallet associated with the rental candidate and managed by the rental asset provision system 102, and the mDL may be accessed and/or utilized by the rental candidate via the smart mobile wallet to execute various mDL-based transactions.

In some examples, an IA may provision an mDL to a particular rental candidate device (e.g., rental candidate device 110A) associated with a rental candidate such that the mDL is associated with various rental candidate device data related to the particular rental candidate device (e.g., cryptographical identification data such as a public key). This may ensure that an mDL associated with a rental candidate cannot be transferred to multiple devices without authorization by the IA system (e.g., IA system 116A) and used in fraudulent transactions. Furthermore, associating an mDL with a particular rental candidate device (e.g., rental candidate device 110A) also enables the rental asset provision system 102 and/or an IA system of an IA (e.g., IA system 116A) to verify that the intended rental candidate of the mDL is in possession of the mDL. Further still, associating an mDL with a particular rental candidate device (e.g., rental candidate device 110A) also ensures the safe transfer of sensitive credential data to and/or from the intended rental candidate of the mDL. In various examples, a rental candidate may store multiple copies of an mDL on multiple rental candidate devices (e.g., rental candidate devices 110A-110N). However, in such examples, each respective copy of the mDL may be cryptographically coupled to a respective rental candidate device by the IA system (e.g., IA system 116A) which provisioned the mDL. In this manner, each copy of the mDL can be independently verified against a respective rental candidate device to ensure that an mDL, or credential data associated with the mDL, cannot be transferred to unauthorized rental candidate devices.

An mDL may be associated with various mDL data security mechanisms used to ensure the validity of the mDL, authenticate an originating IA that issued the mDL, protect a rental candidate's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, rental candidate signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding rental candidate may not be provided with access to the rental asset.

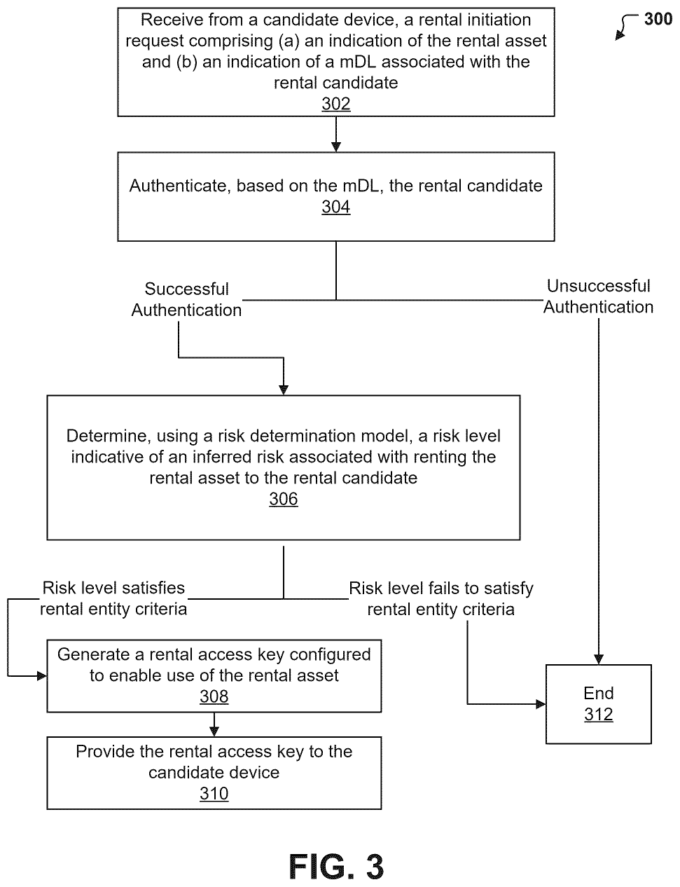

Additionally, an mDL may be associated with various cryptographic key information (e.g., public/private key pair information) that may be utilized by the rental asset provision system 102 to authenticate an originating IA that issued the mDL, verify one or more portions of credential data associated with an mDL, and/or facilitate various mDL-based transactions (e.g., rental candidate authentication protocols, mDL data queries) for a rental candidate associated with the mDL. For example, an IA associated with a respective IA system 116A may be associated with a unique public key that may be utilized by the rental asset provision system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a rental candidate by the rental asset provision system 102 will be described in greater detail herein with reference to FIGS. 3-6.

In some embodiments, the rental asset provision system 102 further comprises and/or integrates with a storage device that comprises a distinct component from other components of the rental asset provision system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Additionally, or alternatively, the storage device may host the software executed to operate the rental asset provision system 102. Additionally or alternatively, the storage device may store information relied upon during operation of the rental asset provision system 102, such as various rental candidate data (e.g., rental candidate information), mDL data (e.g., cryptographical information, credential information), rental entity data (e.g., payment account data, rental candidate transaction data, product and/or service data), smart mobile wallet data (e.g., payment account data, payment card data, and/or the like associated with a rental candidate), distribution data, logistical data, legal data, software application framework data, etc.), and/or the like configured in various data formats to be utilized by the rental asset provision system 102. In addition, the storage device may store control signals, device characteristics, and/or access credentials enabling interaction between the rental asset provision system 102 and/or one or more of the rental candidate devices 110A-110N, rental entity devices 112A-112N, and/or third-party devices 114A-114N.

### Example Implementing Apparatuses

The rental asset provision system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, authentication circuitry 208 and rental management circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a rental entity and/or a rental candidate and, in some embodiments, to receive an indication of input from a rental candidate device 110A, rental entity device 112A, and/or a third-party device 114A. In this regard, the communications hardware 206 may comprise an interface, such as a display, and may further comprise the components that govern use of the interface, such as a web browser, mobile application, dedicated rental candidate device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these interface elements through software instructions (e.g., application software and/or system software, such as firmware) stored on a memory (e.g., memory 204) accessible to the processor 202.

The communications hardware 206 may further be configured to facilitate the execution of one or more mDL authentication and/or IA authentication operations for a rental entity associated with the rental asset provision system 102. In various circumstances, an IA system (e.g., IA system 116A) that previously issued an mDL to a rental candidate may periodically update credential data associated with the mDL (e.g., new rental candidate contact information, updated credential restrictions, updated credential endorsements). As such, the communications hardware 206 may be configured to retrieve and/or receive updated credential data associated with a rental candidate's mDL from an IA system (e.g., IA system 116A) and facilitate the updating of the rental candidate's mDL based on the updated credential data. For example, if an mDL associated with a rental candidate is stored in a smart mobile wallet being managed by the rental asset provision system 102, the communications hardware 206 may be configured to receive updated credential data associated with the rental candidate's mDL from the originating IA system (e.g., IA system 116A) and subsequently update the rental candidate's mDL in the smart mobile wallet based on the updated credential data.

In some embodiments, the communications hardware 206 may update an mDL stored on a rental candidate device (e.g., rental candidate device 110A). In such embodiments, the communications hardware 206 may be configured to query one or more storage devices (e.g., server systems) associated with an IA system (e.g., IA system 116A) in order to retrieve current and/or updated credential data in response to one or more interactions with a rental candidate device interface associated with the smart mobile wallet. Additionally, or alternatively, the communications hardware 206 may be configured to periodically query to one or more storage devices (e.g., server systems) associated with an IA system (e.g., IA system 116A) based on a predefined schedule (e.g., once a day, once a week, once a month, once every 90 days) in order to retrieve current and/or updated credential data associated with a rental candidates' mDL.

In various examples, an IA (e.g., a branch of the DMV) associated with a respective IA system (e.g., IA system 116A) may enforce various mDL data freshness requirements associated with the mDLs the IA system provisions to rental candidates. In this regard, an MSO associated with a respective mDL may indicate a technical validity period associated with the mDL (e.g., a 30-day validity period). As such, the communications hardware 206 may utilize the technical validity period indicated by the MSO to ensure that the credential data associated with the mDL stored on a rental candidate device (e.g., rental candidate device 110A) is updated and/or current. For example, if the communications hardware 206 determines that the technical validity period indicated by the MSO has expired, the mDL may be invalidated until the credential data associated with the mDL is refreshed (e.g., updated, verified) by the IA system 116A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular rental candidate's legal credential, yet the rental candidate fails to have the legal credential (e.g., a corresponding physical credential) updated with said credential restrictions and/or credential endorsements. To address such problems, if the communications hardware 206 determines that the technical validity period indicated by the MSO of the mDL has expired, the corresponding mDL may flag the mDL such that the mDL will fail various authentication protocols during an mDL-based authentication process.

In this regard, the communications hardware 206 may be configured to facilitate the resetting of the technical validity period indicated by the MSO of the mDL in conjunction with a corresponding IA system (e.g., IA system 116A). Additionally, or alternatively, the communications hardware 206 may be configured to facilitate the updating and/or verification of the credential data associated with an mDL stored on a rental candidate device (e.g., rental candidate device 110A) each time the technical validity period associated with the MSO of the mDL is reset. This mDL data security mechanism ensures that the credential data associated with a rental candidate's mDL is always accurate and up to date.

As described herein, an mDL may be associated with various cryptographic key information (e.g., public/private key pair information) that may be utilized by the rental asset provision system 102 to authenticate an originating IA that issued the mDL, verify one or more portions of credential data associated with an mDL, and/or facilitate various mDL-based transactions (e.g., rental candidate authentication protocols, mDL data queries) for a rental candidate associated with the mDL. In this regard, the communications hardware 206 may be configured to generate and/or transmit an IA authentication request comprising a public key associated with an IA to a corresponding IA system 116A in order to verify that a particular mDL was indeed provisioned by the IA associated with the IA system 116A.

In some examples, an mDL may only comprise (e.g., store, point to) identifying information related to a particular IA such that the communications hardware 206 may be configured to first obtain a public key associated with the IA from a corresponding IA system 116A based on the identifying information. Once the public key information associated with the IA is obtained, the communications hardware 206 may be configured to generate an IA authentication request comprising the public key of the IA and transmit the IA authentication request to the IA system 116A (e.g., via the communications network 108). As such, the communications hardware 206 may be configured to receive, from an IA system (e.g., IA system 116A) and in response to the IA authentication request, one or more portions of data indicating whether the IA is a bona fide IA and/or whether the mDL indeed originated from the IA.

Once the communications hardware 206 confirms the validity of the IA and/or confirms that a particular mDL associated with a rental candidate originated from the IA, the communications hardware 206 may be configured to generate a digital token comprising cryptographical information (e.g., public key information) associated with the mDL and the rental candidate. Additionally, in some embodiments, the cryptographical information associated with the mDL and comprised in the digital token may be rental candidate device identification data by which a rental candidate device (e.g., rental candidate device 110A) of the rental candidate may be uniquely identified. In various examples, the communications hardware 206 may generate and/or transmit the digital token to an IA system (e.g., IA system 116A) such that the IA system may decrypt the cryptographical information comprised in the digital token. In this manner, the IA system (e.g., IA system 116A) may authenticate (e.g., verify) one or more portions of credential data associated with the mDL and/or one or more portions of rental candidate device identification data associated with the rental candidate device (e.g., rental candidate device 110A). In this regard, the communications hardware 206 may be configured to receive, from the IA system (e.g., IA system 116A) and in response to transmitting the digital token, one or more portions of data indicating whether the mDL and/or the rental candidate device (e.g., rental candidate device 110A) identified by the digital token is valid. Furthermore, in various examples, the communications hardware 206 may be configured to receive, from the IA system (e.g., IA system 116A) and in response to transmitting the digital token, one or more portions of credential data associated with the mDL.

In some embodiments, the communications hardware 206 may be configured to generate a digital token comprising cryptographical information (e.g., public key information) associated with an mDL and/or a rental candidate device (e.g., rental candidate device 110A) associated with a particular rental candidate in response to an mDL authentication request associated with the particular rental candidate. In some embodiments, the mDL authentication request may be a request to authenticate an mDL associated with the particular rental candidate and thereby authenticate the identity of the particular rental candidate for one or more mDL-based transactions. A respective mDL authentication request may comprise one or more of cryptographical information (e.g., public key information) associated with an mDL and/or a rental candidate device (e.g., rental candidate device 110A). Additionally, or alternatively, a respective mDL authentication request may comprise one or more desired data elements (e.g., one or more desired portions of credential data) associated with the mDL, location data, rental candidate profile data, rental candidate account data, social media data, smart mobile wallet identification data, rental candidate device identification data, and/or the like associated with the particular rental candidate.

In various examples, an mDL validity response received from an IA system (e.g., IA system 116A) based on a digital token generated by the communications hardware 206 may comprise the entirety of the credential data associated with the mDL of the particular rental candidate. Additionally, or alternatively, in various other examples, an mDL validity response received from an IA system (e.g., IA system 116A) based on a digital token generated by the communications hardware 206 may comprise a verification of the desired credential data associated with the mDL that was indicated by an mDL authentication request. Additionally, or alternatively, in various other examples, an mDL validity response received from an IA system (e.g., IA system 116A) based on a digital token generated by the communications hardware 206 may comprise a verification of the rental candidate device identification data associated with the rental candidate device (e.g., rental candidate device 110A) of the particular rental candidate. For example, the mDL validity response may verify that the rental candidate device currently associated with the mDL is the same (e.g., intended) rental candidate device that the mDL was originally provisioned to. In this manner, the rental asset provision system 102 may be configured to confirm the validity of the mDL data of an mDL associated with a particular rental candidate in order to authenticate the identity of the particular rental candidate. Additionally, this enables the rental asset provision system 102 to confirm whether the intended rental candidate and/or rental candidate device (e.g., rental candidate device 110A) associated with the mDL is currently in possession of the mDL.

In various examples, the communications hardware 206 may be configured to receive, from a candidate device, a rental initiation request comprising (a) an indication of the rental asset, (b) an indication of a mDL associated with the rental candidate, and (c) rental candidate information. The communications hardware 26 may further be configured to provide the rental access key to the candidate device and a secondary candidate device. These and other operations associated with the communications hardware 206 will be described in further detail herein below with reference to FIGS. 3-6.

In addition, the apparatus 200 further comprises authentication circuitry 208. In some embodiments, the authentication circuitry 208 may be configured to facilitate the execution of one or more rental candidate authentication operations for a rental entity associated with the rental asset provision system 102. Additionally, the authentication circuitry 208 may utilize processor 202, memory 204, to perform these operations, as described in connection with FIGS. 3-6 below. The authentication circuitry 208 may further utilize the communications hardware 206 to gather data from, or transmit data to, a variety of sources (e.g., one or more of the rental candidate devices 110A-110N, rental entity devices 112A-112N, third-party devices 114A-114N, issuing authority (IA) systems 116A-116N, and/or any storage devices associated with the rental asset provision system 102), and/or exchange data with a rental candidate, a rental entity, and/or a third-party. In some embodiments, the authentication circuitry 208 may work in conjunction with the communications hardware 206 and/or the rental management circuitry 210 in order to execute one or more of the methods described herein. For example, in some embodiments, the authentication circuitry 208 may integrate with and/or otherwise leverage the communications hardware 206 rental management circuitry 210 to facilitate the authentication of a rental candidate based on a respective mDL associated with the rental candidate.

Additionally, the authentication circuitry 208 may be configured to identify a smart mobile wallet associated with a rental candidate and/or the like. For example, the authentication circuitry 208 may identify a smart mobile wallet associated with a rental candidate based on rental candidate information, third-party rental candidate information, and/or the like associated with the rental candidate. In some embodiments, rental candidate information, third-party rental candidate information, and/or the like associated with a rental candidate may comprise rental candidate profile data, rental candidate account data, rental candidate contact data, social media data, location data, and/or smart mobile wallet identification data associated with the rental candidate.

In various examples, once the authentication circuitry 208 identifies a smart mobile wallet that is ostensibly associated with the rental candidate, the authentication circuitry 208 may be configured to generate a rental candidate information request. The authentication circuitry 208 may be configured to leverage the communications hardware 206 to transmit a rental candidate information request to the smart mobile wallet ostensibly associated with the rental candidate. Furthermore, the authentication circuitry 208 may be configured to leverage the communications hardware 206 to receive rental candidate information from the smart mobile wallet ostensibly associated with the rental candidate based on the rental candidate information request.

In various examples, the rental candidate identification data associated with a rental candidate comprises cryptographical information associated with one or more of an mDL and/or a rental candidate device 110A associated with the rental candidate. In some embodiments the cryptographical information associated with the mDL and/or the rental candidate device may be a public key of a public/private key pair, where the public key is provisioned to the rental candidate by an IA upon issuance of the mDL. Such cryptographical information may be utilized by the rental asset provision system 102 and/or an IA system (e.g., IA system 116A) associated with the IA that provisioned the mDL to verify and/or authenticate the mDL, one or more portions of desired mDL credential data, and/or the rental candidate device associated with the rental candidate. In this regard, the authentication circuitry 208 may be configured to determine that the smart wallet ostensibly associated with the rental candidate and/or the like is indeed associated with the rental candidate.

Additionally, or alternatively, in some embodiments, the authentication circuitry 208 may be configured to facilitate execution of secondary authentication of a rental candidate in addition to authenticating the rental candidate based on a corresponding mDL. In this regard, the authentication circuitry 208 may be configured to facilitate the execution of a second factor of authentication including one or more of facial recognition, voice recognition, and/or biometric authentication techniques (e.g., fingerprint recognition, retina recognition, iris recognition). For example, the authentication circuitry 208 may be configured to prompt a rental candidate via a rental candidate device (e.g., rental candidate device 110A) to authenticate themselves via a second factor of authentication (e.g., biometric authentication based on fingerprint data) before allowing the rental candidate to access a smart mobile wallet managed by the rental asset provision system 102.

Additionally, or alternatively, in various embodiments, the authentication circuitry 208 may be configured to prompt a rental candidate via a rental candidate device (e.g., rental candidate device 110A) to authenticate themselves via a second factor of authentication (e.g., voice recognition) either prior to or subsequent to authenticating the rental candidate based on an mDL associated with the rental candidate.

Additionally, or alternatively, in some embodiments, the authentication circuitry 208 may be configured to employ one or more facial recognition techniques to authenticate a rental candidate during a secondary authentication process. For example, authentication circuitry 208 may be configured to authenticate a rental candidate by matching image data related to the rental candidate's face that is captured in real time, or near-real time, (e.g., via a camera of a rental candidate device 110A) to rental candidate portrait image data associated with an mDL related to the rental candidate. In this regard, the authentication circuitry 208 may be configured to generate an image matching score based on matching the image data of the rental candidate's face captured in real time, or near-real time, to the rental candidate portrait image data associated with the rental candidate's mDL.

As such, the authentication circuitry 208 may be configured to determine if an image matching score (e.g., a numerical value or the like) satisfies a respective image matching threshold (e.g., a numerical value or the like). The image matching score may satisfy the respective image matching threshold if the image matching score is greater than or equal to the respective image matching threshold (e.g., to within an error value of +1%, +5%, or any other number). In other examples, the image matching score (e.g., a numerical value or the like) may satisfy the respective image matching threshold (e.g., a numerical value or the like) if the image matching score is less than or equal to the respective image matching threshold (e.g., to within an error value of +1%, +5%, or any other number). In this manner, the authentication circuitry 208 may facilitate secondary authentication techniques in order to authenticate a rental candidate before allowing the rental candidate to access a respective smart mobile wallet via a rental candidate device (e.g., rental candidate device 110A). These and other operations associated with the authentication circuitry 208 will be described in further detail herein below with reference to FIGS. 3-6.

In addition, the apparatus 200 further comprises rental management circuitry 210. In some embodiments, the rental management circuitry 210 may be configured to receive rental candidate information associated with the rental candidate. Additionally, the rental management circuitry 210 may utilize processor 202, memory 204, or any other hardware component included in the apparatus 200 to perform these operations, as described in connection with FIGS. 3-6 below. The rental management circuitry 210 may further utilize the communications hardware 206 to gather data from, or transmit data to, a variety of sources (e.g., one or more of the rental candidate devices 110A-110N, rental entity devices 112A-112N, third-party devices 114A-114N, issuing authority (IA) systems 116A-116N, and/or any storage devices associated with the rental asset provision system 102), and/or exchange data with a rental candidate, rental entity, and/or a third-party. In some embodiments, the rental management circuitry 210 may work in conjunction with the authentication circuitry 208 in order to execute one or more of the methods described herein. For example, in some embodiments, the rental management circuitry 210 may integrate with and/or otherwise leverage the authentication circuitry 208 to facilitate the authentication of the mDL associated with the rental candidate.

In some embodiments, the rental management circuitry 210 may be configured to determine a risk level indicative of an inferred risk associated with renting the rental asset to the rental candidate, wherein the risk level is determined based on the rental asset and rental candidate information. Additionally, the rental management circuitry 210 may utilize processor 202, memory 204, to perform these operations, as described in connection with FIGS. 3-6 below. The rental management circuitry 210 may further utilize the communications hardware 206 to gather data from, or transmit data to, a variety of sources (e.g., one or more of the rental candidate devices 110A-110N, rental entity devices 112A-112N, third-party devices 114A-114N, issuing authority (IA) systems 116A-116N, and/or any storage devices associated with the rental asset provision system 102), and/or exchange data with a rental candidate, rental entity, and/or the like. In some embodiments, the rental management circuitry 210 may work in conjunction with the communications hardware 206 and/or the authentication circuitry 208 in order to execute one or more of the methods described herein, such as selecting a risk assessment type based on the rental asset, wherein the risk assessment type is associated with at least one rental requirement, generating a risk score using a risk determination model, wherein the risk score is generated based on a comparison between the at least one rental requirement and the rental candidate information, and determining the risk level based on the risk score using the risk determination model.

Additionally, or alternatively, in some embodiments, the rental management circuitry 210 may be configured to receive an indication of a secondary rental candidate and secondary rental candidate information. In response to receiving the indication of the secondary rental candidate, the rental management circuitry 210 may be configured to generate, based on the secondary rental candidate information, a secondary rental access key. In some embodiments, the rental management circuitry 210 may work in conjunction with the communications hardware 206 in order to execute one or more of the methods described herein. For example, in some embodiments, the rental management circuitry 210 may integrate with and/or otherwise leverage the communications hardware 206 to provide the rental access key to a secondary candidate device. These and other operations associated with the rental management circuitry 210 will be described in further detail herein below with reference to FIGS. 3-6.

Although components 202-210 are described in part using functional language, it will be understood that the particular implementations necessarily include the use of particular hardware. It should also be understood that certain of these components 202-210 may include similar or common hardware. For example, the authentication circuitry 208 and./or the rental management circuitry 210 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” and/or “engine” with respect to elements of the apparatus therefore shall be interpreted as necessarily including the particular hardware configured to perform the functions associated with the particular element being described. Of course, while the term “circuitry” and/or “engine” should be understood broadly to include hardware, in some embodiments, the term “circuitry” and/or “engine” may, in addition, refer to software instructions that configure the hardware components of the apparatus 200 to perform the various functions described herein.

Although the authentication circuitry 208 and/or the rental management circuitry 210, may leverage processor 202, memory 204, and/or communications hardware 206 as described above, it will be understood that any of authentication circuitry 208 and/or the rental management circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that authentication circuitry 208 and/or the rental management circuitry 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-6, example flowcharts are illustrated that contain example operations implemented by example embodiments described herein. The operations illustrated in FIGS. 3-6 may, for example, be performed by system device 104 of the rental asset provision system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, authentication circuitry 208, rental management circuitry 210, and/or any combination thereof. It will be understood that user interaction with the rental asset provision system 102 may occur directly via communications hardware 206 or may instead be facilitated by a separate rental candidate device 110A-110N and/or rental entity device 112A-112N, as shown in FIG. 1, and which may have similar or equivalent physical componentry facilitating such user interaction.

Turning first to FIG. 3, a procedure 300 illustrates example operations for providing a rental candidate with access to a rental asset, wherein the apparatus 200 includes means such as processor 202, memory 204, communications hardware 206, authentication circuitry 208, rental management circuitry 210, or the like.

As shown by operation 302, the apparatus 200 includes means such as communications hardware 206, rental management circuitry 210, or the like, for receiving, from a candidate device, a rental initiation request comprising (a) an indication of the rental asset, (b) an indication of a mobile driver's license (mDL) associated with the rental candidate, and (c) rental candidate information. A rental initiation request may refer to a communication received by a rental entity device 112A from a rental candidate device 110A to initiate the process for renting a rental asset. The rental initiation request may comprise two key components: an indication of the rental asset the rental candidate seeks to rent, and an indication of the mDL associated with the rental candidate that identifies the rental candidate requesting access to the rental asset. Examples of rental assets include automobiles, hotel rooms, rental properties, smart lockers, recreational equipment (e.g., bicycles, kayaks, music gear, etc.), event spaces, and/or the like.

For a particular rental event, communications hardware 206 may receive a rental initiation request from a rental candidate device (e.g., rental candidate device 110A) associated with a rental candidate. In such embodiments, wherein the rental candidate submits the rental initiation request, the rental candidate may use the rental candidate device (e.g., rental candidate device 110A) to submit the rental initiation request through a web portal associated with the rental entity, via a mobile application provided by the rental entity, and/or the like. In particular, the rental candidate device 110A-110N may establish a communication link via communications hardware 206 with a rental entity device 112A-112N via available network protocols (e.g., Bluetooth, near-field communication (NFC) (e.g., tapping the rental candidate device 110A against an NFC-enabled rental entity device 112A), Wi-Fi, internet protocols such as HTTP/HTTPS)., and/or the like. A rental candidate device 110A may establish a secure connection the rental entity's server using encryption protocols, such as TLS/SSL to ensure data privacy and integrity. Alternatively, the data entered by the rental candidate as part of the rental initiation request may be packaged into a standard format (e.g., JSON or XML) and transmitted to the system device 104 of the rental asset provision system 102 via an application programming interface (API) or web service call.

In some embodiments, a rental entity device 112A may also prompt the rental candidate through communications hardware 206 to submit a rental initiation request. For instance, the rental entity device may continuously monitor for the presence of nearby rental candidate devices using various proximity detection technologies such as Bluetooth, NFCs, Wi-Fi, and/or the like. Once, the rental entity device 112A detects a nearby device, the rental entity device 112A may be configured to use communications hardware 206 and attempt to identify the detected device as a potential rental candidate device 110A. This may be done via the implementation of device handshake protocols (i.e., engaging in initial communication exchanges with the detected device to verify that the detected device is compatible and supports the necessary rental initiation request protocols), service discovery (e.g., querying the detected device for specific services or applications required for the rental process), and/or the like. Upon successful identification of a rental candidate device 110A, the rental entity device 112A may leverage communications hardware 206 to trigger a prompting mechanism to output a prompt to the rental candidate device and request the rental candidate to submit a rental initiation request. In some embodiments, the prompt may be a visual prompt (e.g., displaying messages or instructions on the rental candidate device 110A or the rental entity device 112A via a kiosk or smart terminal screen), audible prompt (e.g., emitting sounds or voice instructions to attract the attention of the rental candidate), device notifications (e.g., transmitting push notifications or messages directly to the rental candidate device 110A through a mobile application notification or text message), and/or the like. Accordingly, the rental candidate may submit a rental initiation request through an outputted prompt.

In some embodiments in which a guided user interface (GUI) is displayed on the rental candidate device 110A, the GUI may provide step-by-step instructions for submission of a rental initiation request. The GUI may allow the rental candidate to input an indication of the rental asset, the mDL associated with the rental candidate, rental candidate information, and/or the like. Additionally, the rental candidate may input further data related to the (i) rental asset type (e.g., the category or type of rental candidate item-hotel room, rental property, smart locker, etc.), (ii) rental asset details (e.g., make and model of a car, room type and amenities for the hotel), rental period of interest (i.e., start date and time for the rental period), location information (e.g., pickup location, return location, return property address), payment information (e.g., payment method to be used, payment authorization such as a pre-authorization amount), special requests (e.g., child seat for a car rental), rental candidate preferences (e.g., smoking or non-smoking room), and/or the like. As part of the rental initiation request, the rental candidate must also provide an indication (i.e., identifying information of the rental candidate such as name, user ID, email address, contact information) and a mobile driver's license as supporting documentation for the indication. Upon filling all data fields of the rental initiation request, the rental candidate may submit the rental initiation request, after which communications hardware 206 of the rental asset provision system 102 may receive and transmit the rental initiation request securely to the internal network of the rental entity (e.g., through an intranet or secure API call to the backend server). The system device 104 may log the rental initiation request, noting the rental candidate who submitted the rental initiation request, an identifier associated with the rental candidate device 110A from which the rental initiation request originated from, and a corresponding timestamp indicating the time at which the rental initiation request was submitted.

Upon receiving the rental initiation request, the rental management circuitry 210 may be configured to process the rental initiation request by performing an initial integrity check to ensure that the received rental initiation request has not been corrupted during transmission. This may involve verifying checksums or digital signatures. Additionally, the rental management circuitry 210 may check that the data fields in the rental initiation request conform to the expected format and structure, ensuring that all required data fields are present and correctly formatted. Subsequently, the rental management circuitry 210 may cause processing of the received rental initiation request for interpretation of the data fields included in the rental initiation request. In some embodiments, the rental management circuitry 210 may do this by extracting individual data fields (e.g., the rental asset, an indication of the rental asset, and an indication of a mDL associated with the rental candidate, etc.), from the rental initiation request and may subsequently organize the extracted data into a structured format, typically as objects or records that may be easily processed further. For instance, the rental management circuitry 210 may ensure that the extracted data fields are correctly associated with their respective entities (e.g., linking the indication of the rental asset and the indication of the mDL associated with the rental candidate with the corresponding rental asset in the internal network of the rental asset provision system 102). In some embodiments, the rental management circuitry 210 may validate the structured data to ensure that the data values make sense within the context of the rental event (e.g., checking rental asset availability to ensure that the rental asset is available for the specified dates, ensuring that the rental candidate contact information adheres to expected formats, etc.). In some embodiments, the rental management circuitry 210 may temporarily store the parsed and validated rental candidate information in memory 204 for further processing. This allows the rental asset provision system 102 to maintain the context of the rental initiation request as it progresses through subsequent steps of the rental asset provision process.

If the rental initiation request does not include a mDL associated with the rental candidate, the communications hardware 206 may output a mDL request to the rental candidate device 110A from which the rental initiation request was originally received, to request the rental candidate to resubmit the rental initiation request with the mDL of the rental candidate. The communications hardware 206 may also perform the aforementioned operation in instances in which the rental candidate mDL in the rental initiation request is unreadable.

In alternate embodiments, wherein the communications hardware 206 detects that the mDL of the rental candidate is missing from the rental initiation request, the communications hardware 206 may automatically retrieve the mDL from the rental candidate device 110A (e.g., from a smart mobile wallet of the rental candidate device 110A with the consent of the rental candidate), or may retrieve the rental candidate mDL from a mDL database in storage device 106 of the rental asset provision system 102 (e.g., in cases where the rental candidate's mDL was stored for a former rental initiation request). Additionally, in alternate embodiments, wherein the communications hardware 206 detects that the rental candidate mDL is missing from the rental initiation request and/or that the rental candidate mDL is corrupted, the communications hardware 206 may automatically failover to a traditional rental asset provision process.

As shown by operation 304, the apparatus 200 includes means such as communications hardware 206, authentication circuitry 208, or the like, for authenticating, based on the rental initiation request, the mDL associated with the rental candidate.

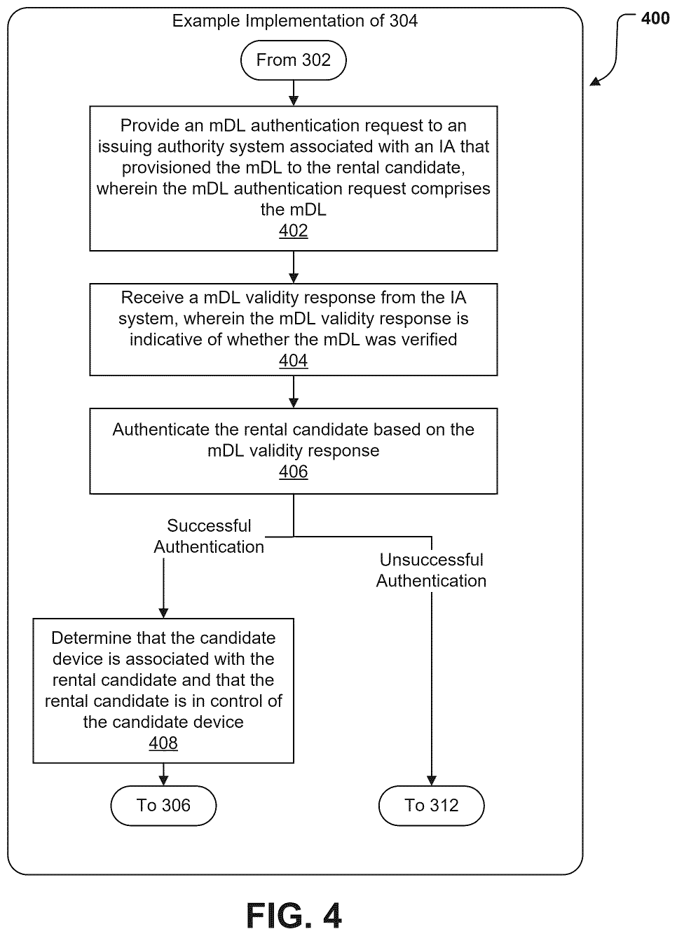

In some embodiments, operation 304 may be performed in accordance with the operations described in FIG. 4. Turning now to FIG. 4, a procedure 400 illustrates example operations for authenticating, based on the rental initiation request, the mDL associated with the rental candidate.

As shown by operation 402, the apparatus 200 includes means such as communications hardware 206, authentication circuitry 208, or the like, for providing an mDL authentication request to an issuing authority (IA) system associated with an IA that provisioned the mDL to the rental candidate, wherein the mDL authentication request comprises the mDL. The mDL authentication request is a request to authenticate the mDL of the rental candidate. The mDL authentication request comprises the mDL provided as part of the rental initiation request and may be transmitted by communications hardware 206 to an issuing authority system 116A-116N that provisioned the particular mDL to the rental candidate. In some embodiments, the communications hardware 206 may be configured to facilitate the execution of the mDL authentication request based on one or more present or missing features associated with the mDL authentication request. Based on the features that are missing or present (e.g., cryptographic information, desired credential data), the communications hardware 206 may generate an mDL authentication request accordingly. For instance, if the mDL provided by the rental candidate also provided cryptographic information required to decrypt the encrypted mDL, the mDL authentication request may already include the cryptographic information and may not request an issuing authority system 116A for the same, as part of the mDL authentication request.

In some embodiments, the authentication circuitry 208 may generate a digital token based on the mDL authentication request. By way of continued example, the authentication circuitry 208 may be configured to generate a digital token comprising cryptographic information (e.g., public key information) associated with the mDL of the rental candidate. Additionally, in some embodiments, the cryptographic information associated with the mDL of the rental candidate and comprised in the digital token may enable unique identification of the rental candidate device 110A associated with the rental candidate.

By way of continued example, the authentication circuitry 208 may leverage the communications hardware 206 to transmit the digital token to an IA system (e.g., IA system 116A) associated with the IA that provisioned the mDL to the rental candidate, such that the IA system (e.g., IA system 116A) may decrypt the cryptographic information comprised in the digital token. In this manner, the IA system (e.g., IA system 116A) may verify one or more portions of credential data associated with the rental candidate device 110A of the rental candidate.

In some embodiments, the authentication circuitry 208 may determine that the IA that provisioned the mDL may no longer be applicable to the rental candidate (e.g., in situations where the rental candidate has moved to a different state). In such cases, the authentication circuitry 208 may be configured to determine the correct IA system (e.g., a different IA system) associated with the rental candidate, such that the respective digital tokens generated based on respective mDL authentication requests are routed to the correct IA systems. In this manner, the rental asset provision system 102 ensures the safe transmission of the respective digital tokens and the successful authentication of the mDL associated with a rental candidate.

As shown by operation 404, the apparatus 200 includes means such as communications hardware 206, or the like, for receiving, by the communications hardware, a mDL validity response from the IA system, wherein the mDL validity response is indicative of whether the mDL was verified. For example, the communications hardware 206 may receive the mDL validity response from the IA system (e.g., IA system 116A) associated with the IA that provisioned the mDL to the rental candidate. In some embodiments, the mDL validity response is generated based on the digital token associated with the rental candidate and/or the rental candidate device 110A associated with the rental candidate. In some examples, the mDL validity response indicates verified credential data (e.g., desired credential data) associated with the mDL indicated by the mDL authentication request. Furthermore, in some examples, the mDL validity response may also indicate verified information related to the rental candidate device associated with the rental candidate (e.g., rental candidate device 110A).

As shown by operation 406, the apparatus 200 includes means such as communications hardware 206, authentication circuitry 208, or the like, for authenticating the rental candidate based on the mDL validity response. By way of continued example, the authentication circuitry 208 may be configured to authenticate the rental candidate based on the authenticated mDL comprised in the mDL validity response received from the IA system (e.g., one of IA systems 116A-116N). In this manner, the rental asset provision system 102 may be configured to authenticate the rental candidate based on their authenticated mDL.

As shown by operation 408, the apparatus 200 includes means such as communications hardware 206, authentication circuitry 208, or the like, for determining that the candidate device is associated with the rental candidate and that the rental candidate is in control of the candidate device. Once the communications hardware 206 authenticates the rental candidate based on the mDL validity response, the communications hardware 206 may verify that the rental candidate is in control of the rental candidate device 110A by capturing in real-time an image of the rental candidate associated with the rental candidate device 110A. In some embodiments, the communications hardware 206 may store the captured image for future comparison against the mDL submitted as part of the rental initiation request. In some embodiments, the communications hardware 206 may output an image capture request to the rental candidate device 110A. Subsequently, the captured image may be securely transmitted from the rental candidate device 110A to the authentication circuitry 208 via communications hardware 206. The authentication circuitry 208 may perform real-time analysis and verification of the captured image using advanced facial recognition algorithms. In particular, the authentication circuitry 208 may verify facial features of the rental candidate such as eyes, nose, mouth, overall facial structure by comparing them against the facial features present in the mDL of the rental candidate.

In some embodiments, the authentication circuitry 208 may implement anti-spoofing measures (e.g., liveness detection such as blinking and facial movements, depth analysis, etc.) to ensure authenticity of the captured image. Based on a comprehensive analysis of the aforementioned features, the authentication circuitry 208 may determine that the rental candidate is in control of the rental candidate device 110A, in which case subsequent operations may be performed as described below.

Returning to FIG. 3, operations 306-310 may occur in response to authenticating the mDL associated with the rental candidate.

Returning to FIG. 3, as shown by operation 306, the apparatus 200 includes means such as rental management circuitry 210, or the like, for determining, using a risk determination model, a risk level indicative of an inferred risk associated with renting the rental asset to the rental candidate, wherein the risk level is determined based on the rental asset and the rental candidate information.

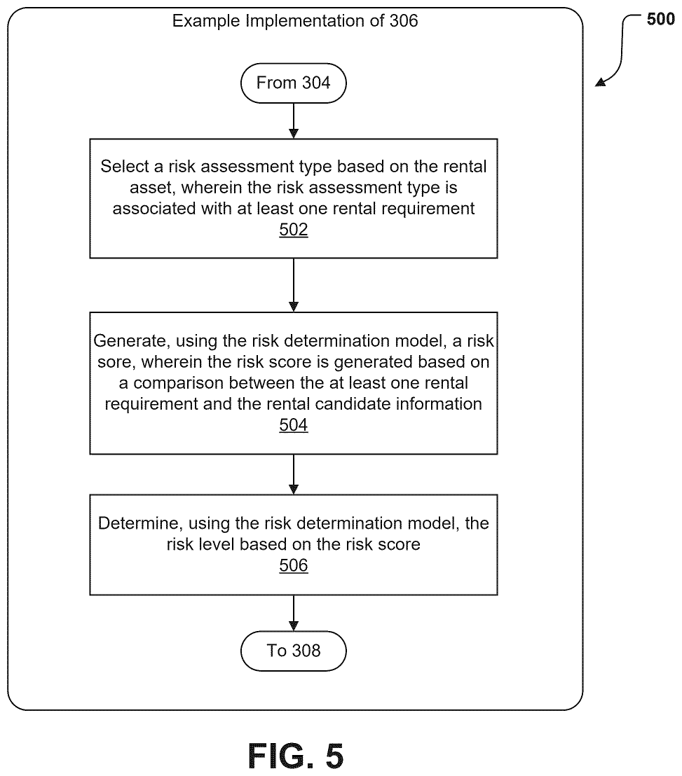

In some embodiments, operation 308 may be performed in accordance with the operations described in FIG. 5. Turning now to FIG. 5, a procedure 500 illustrates example operations for determining, using a risk determination model, a risk level indicative of an inferred risk associated with renting the rental asset to the rental candidate, wherein the risk level is determined based on the rental asset and the rental candidate information.

As shown by operation 502, the apparatus 200 includes means such as communications hardware 206, rental management circuitry 210, or the like, for selecting a risk assessment type based on the rental asset, wherein the risk assessment type (e.g., low risk assessment, medium risk assessment, high risk assessment) is associated with at least one rental requirement. The predefined rental requirements may be criteria set by the rental entity to ensure that the rental candidate is a suitable match for the rental asset and to mitigate risk for the rental entity. Consider a scenario where a rental candidate seeks to rent a luxury car. The rental management circuitry 210 may query the internal database of the rental asset provision system 102 to identify the rental requirements associated with renting a high-value vehicle, such as requiring the rental candidate to have a high credit score (e.g., above 700), proof of high income or substantial financial assets, clean driving record, no history of vehicle-related claims or disputes. Based on the identified rental requirements, the rental management circuitry 210 may consequently select a high-risk assessment type to determine whether the rental candidate should be provided with access to the rental asset. In some embodiments, the rental management circuitry 210 may be provided with predefined risk assessment type categories for various rental assets, such that upon identifying the rental asset, the rental management circuitry 210 simply needs to query an internal database of the rental entity to identify the risk assessment type appropriate for the particular rental asset.

In some embodiments, the rental management circuitry 20 may also select a risk assessment type based on the rental candidate information provided as part of the rental initiation request. For instance, if a rental candidate seeks to rent a low-value car, in typical scenarios the rental management circuitry 210 may select a low to medium risk assessment type. However, if the rental candidate information indicates that the rental candidate has low income, the rental management circuitry 210 may still opt to select a high-risk assessment type.

As shown by operation 504, the apparatus 200 includes means such as communications hardware 206, rental management circuitry 210, or the like, for generating, using the risk determination model, a risk score, wherein the risk score is generated based on a comparison between the at least one rental requirement and the rental candidate information. In some embodiments, the process of generating a risk score involves comparing each data field in the rental candidate information to the corresponding predefined rental requirements of a rental entity, specific to the type of rental asset. By way of continued example, a rental candidate seeking to rent a luxury car must require a credit score of at least 700. The rental candidate's score, as verified through communications with the trusted third-party device 114A (e.g., a financial institution) may be 750. As the rental candidate's score exceeds the minimum threshold, this comparison results in a positive outcome, contributing to a lower overall risk for renting the luxury car.

In some embodiments, the risk determination model may be a machine learning model that assigns each data field in the rental candidate information a weight, based on its relative important to the overall risk assessment. For example, a credit score may be given more weight than rental history in the context of high-value vehicle rentals, as financial stability is considered more critical. As such, the risk determination model may normalize the data fields to ensure that they are on a comparable scale by transforming the data into a standard range (e.g., between 0 and 1), to facilitate effective comparison and combination in the risk determination model. Continuing with the aforementioned example, if the rental candidate's score of 750 is normalized on a scale where the maximum possible score is 850, the normalized score might be around 0.88. If the income requirement is an annual salary of $100,000 and the rental candidate's income is $120000, this could be normalized to a value of 1 (assuming $120,000 is the upper cap for normalization). These normalized values may allow the risk determination model to process different types of data on a unified scale. The normalized and weighted data fields may be fed into the risk determination model, which has been trained on historical data to predict the risk associated with various rental scenarios and rental assets. The risk determination model may use these inputs to generate a risk score by analyzing patterns and relationships within the data to infer the likelihood of a rental candidate meeting the rental requirements and obligations without incidents. For instance, the risk determination model might recognize that rental candidates with a credit score above 700 and an annual income above $100000 have historically had very low default rates in high-value vehicle rentals. Based on this pattern, the risk determination model may assign a lower risk score to the rental candidate. If the rental candidate's other data fields (e.g., rental history: no prior defaults, background checks, etc.) also meet or exceed the rental requirements, these would further contribute to a favorable risk assessment. Subsequently, the risk determination model may process the combined, normalized data fields to generate and output a composite risk score to the rental management circuitry 210. The risk score may refer to a numerical value that represents the overall risk level of renting the rental asset to the rental candidate.

In some embodiments, the risk determination model may be a rules-based system that allows a third-party (e.g., a bank) to compare the rental candidate information against the predefined rental requirements set by the rental entity. In particular, the rental entity may provide the third party with the rental requirements for renting a particular rental asset. For instance, if the rental entity requires proof of income over a particular credit score to rent a luxury car, the rental entity may provide the required credit sore to the third-party device 114A. Upon receiving this information, the third-party device 114A may query their internal database to verify the proof of income of a rental candidate. In such embodiments, this automated risk determination process would mean that the rental candidate is no longer required to share personal information as part of the rental initiation request, which consequently would prevent the rental entity from storing such personal identifying information received as part of the rental initiation request.

As shown by operation 506, the apparatus 200 includes means such as communications hardware 206, rental management circuitry 210, or the like, for determining, using the risk determination model, the risk level based on the risk score. Based on the outputted risk score, the rental management circuitry 210 may interpret the risk score according to predefined risk levels. For example, a risk score may be categorized into the following risk levels: low risk (0-0.3), medium risk (0.3-0.6), and high risk (0.61-1.0). In reference to the example mentioned above, the rental candidate seeking to rent a luxury car, with a strong credit score, high income, and positive rental history may result in a risk score of 0.25, categorizing them as a low-risk rental candidate. This categorization may trigger the generation of a rental access key, as described below in operation 308. Determining the risk level for renting a rental asset to a rental candidate simplifies the decision-making process for the rental entity, enabling them to quickly assess the rental candidate's suitability for renting the luxury car.

Upon determining the risk level, the process by which the rental management circuitry 210 may convey the determined risk level to the rental entity may vary based on the rental asset type and the requirements preestablished by a particular rental entity. In one example embodiment, the risk level may be represented by rental management circuitry 210 based on a series of color-coded suitability indications indicating whether the rental entity should rent the rental asset to the rental candidate. The suitability indication may be green (“proceed with renting the asset to the rental candidate”), red (“do not proceed with renting the rental asset to the rental candidate”), and/or the like, as determined by the third-party or required by the rental entity. In some embodiments, the rental entity may have predefined the color indications based on their rental requirements criteria, wherein each color represents a different outcome based on the risk assessment and compliance with the rental requirements. If the risk score and risk level indicate that a rental asset may be rented to the rental candidate, the rental management circuitry 210 may generate a green suitability indication, indicating that the rental candidate meets all the rental requirements and poses a low risk. Alternatively, if the risk score and risk level indicate that a rental asset should not be rented to the rental candidate, the rental management circuitry 210 may generate a red suitability indication and transmit the same to the rental entity device 112A, indicating that the rental candidate does not meet one or more of the rental requirements and poses a high risk.

In some embodiments, the risk score and risk level may not clearly indicate whether a rental asset should be rented to the rental candidate, in which case a yellow suitability indication may be generated and transmitted to the rental entity device 112A. In instances in which it is not clear whether a rental candidate item should be rented to a rental candidate, a yellow suitability indication may be generated by the rental management circuitry 210 and outputted by the communications hardware 206 to the rental entity device 112A. However, in alternate embodiments, the yellow suitability indication may not be outputted to the rental entity device 112A. In the latter case, it would be up to the rental entity to decide whether the rental asset should be rented to the rental candidate. Once the decision has been made, the rental entity may default to providing a predefined color-coded suitability indication of green or red, as previously described above.

In some embodiments, in which a yellow suitability indication is outputted to the rental entity device 112A by the communications hardware 206, consider the following scenario where the credit score threshold is 700 and a rental candidate has a credit score of 690. In this case, the rental entity device 112A, upon receiving a yellow suitability indication, may request the trusted third-party device 114A to verify the credit score and provide more context pertaining to the yellow suitability indication. If the rental candidate provides consent and/or has provided consent in the past to share such contextual details with a rental entity, the trusted third-party device 114A may share the requested contextual information with the rental entity device 112A to help them with determining whether the rental asset should be rented to the rental candidate. In some embodiments, the requested contextual information may be quantitative in nature (e.g., credit score), whereas in alternate embodiments, the requested contextual information may be qualitative in nature (e.g., address).

In some embodiments, communications hardware 206 may provide the determined risk level to the rental entity device 112A in example formats such as a visual dashboard (e.g., charts, graphs, and other visual tools to convey risk levels and data insights), numerical risk scores, risk categories (low risk, medium risk, high risk, very high risk, etc.), a detailed risk report (e.g., comprehensive analysis of the rental candidate's risk factors such as credit score, income, rental history, etc.), conditional approval, segmented feedback (e.g., separate evaluations for financial stability, identity verification, and rental history), predictive insights (e.g., predictions about the rental candidate' future behavior based on available historical rental data), comparative analysis (e.g., comparison between the rental candidate and a benchmark or average profile of successful renters), behavioral scores (e.g., evaluating the rental candidate's behavioral pattern based on historical data such as consistency in payment history, frequency of rental applications, etc.), and/or the like.

Returning to FIG. 3, operations 308-310 may occur in response to the risk level satisfying rental entity criteria.

As shown by operation 308, the apparatus 200 includes means such as rental management circuitry 210, or the like, for generating, based on the rental candidate information, a rental access key configured to enable use of the rental asset. This process ensures that only authorized rental candidates have access to the rental asset. Upon determining that the risk level satisfied the rental requirements to rent the rental asset to the rental candidate, the rental management circuitry 210 may be triggered to generate a rental access key for the duration requested by the rental candidate. In some embodiments, the rental management circuitry 210 may compile all data provided as part of the rental candidate information (e.g., rental candidate mDL, rental asset details, rental periods, specific access conditions, etc.) and may then use cryptographic techniques to encrypt the rental candidate information into a rental access key. Following the aforementioned step, the rental management circuitry 210 may tokenize the rental access key by transforming the rental access key into a secure, unique string of characters that may be transmitted and verified by a rental entity device that is configured to provide access to the rental asset. For instance, a tokenized rental access key may be a Base64 encoded string or a JWT (JSON Web Token) containing encrypted information about the rental candidate information. In alternate embodiments, the rental access key may be generated as a barcode or QR code. This format may be particularly useful for physical access systems, such as smart locks or automated entry gates. The barcode or QR code generated by the rental management circuitry 210 may contain all necessary encrypted information. The generated rental access key may then be provided to the candidate device as described below in connection with operation 310.

Returning to FIG. 3, as shown by operation 310, the apparatus 200 includes means such as communications hardware 206, rental management circuitry 210, or the like, for providing the rental access key to the candidate device. Once the rental access key is generated, the rental management circuitry 210 may prepare it for transmission. Depending on the format (e.g., tokenized string, barcode, QR code, etc.), the rental access key may be further encoded or converted into a suitable format for delivery. In some embodiments, the rental management circuitry 210 may determine the most appropriate and secure channel for providing the rental access key to the candidate device (e.g., via mobile apps, SMS, email, or secure web portals). If the rental candidate has a rental management mobile app installed for the particular rental entity, the rental access key may be directly pushed to the rental management mobile app. The communications hardware 206 may use an API call to the rental management mobile app's backend server, which may then send a notification to the rental candidate device 110A. The rental management mobile app may receive the notification, decrypt the rental access key, and may securely store the rental access key within the wallet of the rental management mobile app for easy access.

In alternate embodiments, if the rental management mobile app is not available or preferred, the rental access key may be provided via SMS or email. The rental management circuitry 210 may generate a secure link or attachment containing the rental access key, which may then be transmitted to the rental candidate's registered phone number of email address.

For embodiments where high security is required, the rental access key may be provided through a secure web portal. The rental candidate may receive a notification (via SMS or email) with instructions to log into the portal using their credentials. Once logged in, the rental candidate may be allowed to download or view the rental access key.

Following provision of the rental access key to the rental candidate, the rental management circuitry 210 may ensure that the rental candidate device 110A successfully received the rental access key by checking delivery receipts for SMS or email or confirming that the rental management mobile app has acknowledged receipt of the rental access key. If any issues arise, the rental management circuitry 210 may reinitiate the rental access key provision process.

Upon receiving the rental access key, the rental candidate may use the rental access key to access the rental asset. For instance, the rental candidate may scan a QR code at the rental site, input the token into a smart lock system, or present the rental access key via the rental management mobile app to gain access to a rental asset (e.g., a vehicle).

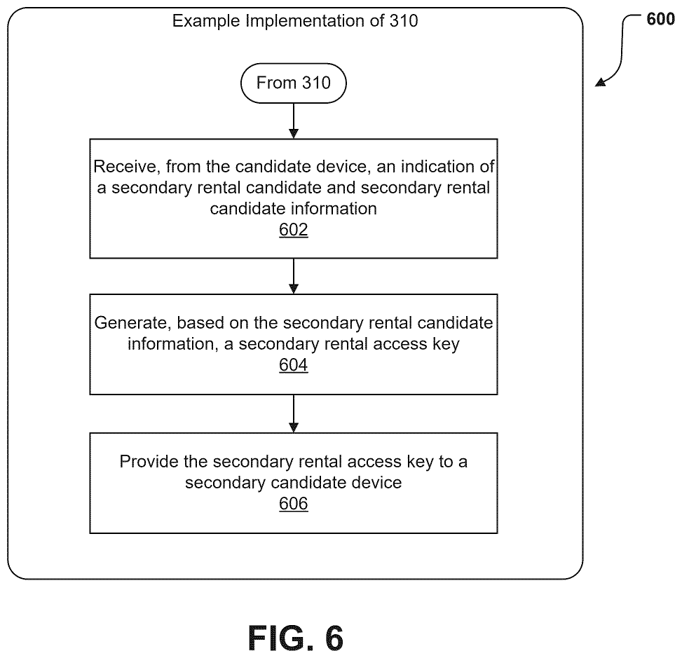

In cases where the rental asset must be shared with secondary rental candidates, the rental asset provision system 102 may trigger performance of the sequence of operations set forth in FIG. 6 and described below.

Turning now to FIG. 6, a procedure 600 illustrates example operations for providing the rental access key to the candidate device.

As shown by operation 602, the apparatus 200 includes means such as rental management circuitry 210, or the like, for receiving, from the candidate device, an indication of a secondary rental candidate and secondary rental candidate information. Upon providing the rental access key to the rental candidate, the rental management circuitry 210 may transmit a secondary prompt to the candidate device through the designated communication channel (e.g., mobile app, SMS, email, etc.). The secondary prompt may ask the rental candidate to indicate whether access to the rental asset needs to be shared with a secondary rental candidate. The rental candidate may indicate through the prompt whether a secondary rental candidate must be provided with access to the rental asset. If so, the rental management circuitry 210 may guide the rental candidate to a secure form or interface where the rental candidate may input the secondary rental candidate information (E.g., name, phone number, email address, secondary rental candidate mDL if available, etc.), particularly details that would enable secure delivery of the rental access key. Once the form has been completed, the communications hardware 206 may transmit this data back to the rental asset provision system 102, after which the rental management circuitry 210 may generate a secondary rental access key, as described below in connection with operation 604.

As shown by operation 604, the apparatus 200 includes means such as rental management circuitry 210, or the like, for generating, based on the secondary rental candidate information, a secondary rental access key, wherein the secondary rental access key is configured to enable use of the rental asset for the secondary rental candidate. This process ensures that only authorized secondary rental candidates have access to the rental asset. Based on the provided indication of the secondary rental candidate information, the rental management circuitry 210 may be triggered to generate a secondary rental access key. In some embodiments, the secondary rental access key may be the exact same as the rental access key provided to the rental candidate, especially in cases where the rental candidate has not established access limitations for the secondary rental candidate. However, in alternate embodiments, the secondary rental access key may be a different secondary rental access key than that provided to the rental candidate, particularly in cases where the rental candidate has established access limitations for the secondary rental candidate (e.g., a young adult may not be permitted to access a rental car post 9 pm). As such, a secondary rental access key may integrate access limitations (e.g., time limitations, frequency of use, etc.), as dictated by the rental candidate.

To generate the rental access key, the rental management circuitry 210 may compile all data provided as part of the secondary rental candidate information (e.g., secondary rental candidate mDL, rental asset details, rental periods, specific access conditions, etc.) and may then use cryptographic techniques to encrypt the secondary rental candidate information into a secondary rental access key. Following the aforementioned step, the rental management circuitry 210 may tokenize the secondary rental access key by transforming the secondary rental access key into a secure, unique string of characters that may be transmitted and verified by a rental entity device configured to provide access to the rental asset. For instance, a tokenized secondary rental access key may be a Base64 encoded string or a JWT (JSON Web Token) containing encrypted information about the secondary rental candidate information. In alternate embodiments, the secondary rental access key may be generated as a barcode or QR code. This format may be particularly useful for physical access systems, such as smart locks or automated entry gates. The barcode or QR code generated by the rental management circuitry 210 may contain all necessary encrypted information. The generated secondary rental access key may then be provided to the secondary candidate device as described below in connection with operation 606.

As shown by operation 606, the apparatus 200 includes means such as communications hardware 206, or the like, for providing the secondary rental access key to a secondary candidate device. Once the secondary rental access key is generated, the rental management circuitry 210 may prepare it for transmission. Depending on the format (e.g., tokenized string, barcode, QR code, etc.), the secondary rental access key may be further encoded or converted into a suitable format for delivery. In some embodiments, the rental management circuitry 210 may determine the most appropriate and secure channel for providing the secondary rental access key to the secondary candidate device (e.g., via mobile apps, SMS, email, or secure web portals). If the rental candidate has a rental management mobile app installed for the particular rental entity, the secondary rental access key may be directly pushed to the rental management mobile app. The communications hardware 206 may use an API call to the rental management mobile app's backend server, which may then send a notification to the secondary rental candidate device. The rental management mobile app may receive this notification, decrypt the secondary rental access key, and may securely store the secondary rental access key within the wallet of the rental management mobile app for easy access.

In alternate embodiments, if the rental management mobile app is not available or preferred, the secondary rental access key may be provided via SMS or email. The rental management circuitry 210 may generate a secure link or attachment containing the secondary rental access key, which may then be transmitted to the secondary rental candidate's registered phone number or email address.

For embodiments where high security is required, the secondary rental access key may be provided through a secure web portal. The secondary rental candidate may receive a notification (via SMS or email) with instructions to log into the portal using their credentials. Once logged in, the secondary rental candidate may be allowed to download or view the secondary rental access key.

Following provision of the secondary rental access key to the secondary rental candidate, the rental management circuitry 210 may ensure that the secondary rental candidate device successfully received the secondary rental access key by checking delivery receipts for SMS or email or confirming that the rental management mobile app has acknowledged receipt of the secondary rental access key. If any issues arise, the rental management circuitry 210 may reinitiate the secondary rental access key provision process.

Upon receiving the secondary rental access key, the secondary rental candidate may use the secondary rental access key to access the rental asset. For instance, the secondary rental candidate may scan a QR code at the rental site, input the token into a smart lock system, or present the secondary rental access key via the rental management mobile app to gain access to a rental asset (e.g., a vehicle).

Returning to FIG. 3, as shown by operation 312, the apparatus 200 includes means such as authentication circuitry 208, or the like, for ending procedure 300 in response to an unsuccessful authentication of the mDL associated with the rental candidate or ending procedure 300 in response to the risk level failing to satisfy rental entity criteria. In some embodiments, if the authentication circuitry 208 determines that the rental candidate's mDL is inauthentic or that the risk level fails to satisfy rental entity criteria, the authentication circuitry 208 may be configured to generate a rental failure alert. In particular, a rental failure alert may be an alert, notification, warning, advisory, and/or the like that indicates various data related to a failed mDL authentication attempt or a high-risk level for renting the rental asset to the rental candidate. The failure alert may comprise data (e.g., rental candidate information, timestamp data associated with the mDL authentication attempt, geolocation data associated with the rental candidate during a time in which the mDL authentication attempt was executed, as indicated by GPS data collected and/or generated by a rental candidate device 110A, risk level, the rental requirements used to determine the risk level, etc.) related to a rental candidate whose mDL was not successfully verified to be authentic or may be related to a rental candidate for whom a high risk level was determined.

In some embodiments, a rental failure alert may be configured as a notification, email, text message, direct application message (e.g., via a software application instance associated with the rental asset provision system 102), audio message (e.g., automated voice message), banner notification, and/or the like. The authentication circuitry 208 may be configured to leverage the communications hardware 206 to transmit the rental failure alert to one or more computing devices (e.g., rental candidate device 110A-110N, rental entity device 112A-112N, third-party device 114A-114N, IA systems 116A-116N, and/or the like) via a number of different communication methods over a communications network (e.g., communications network 108).

In alternate embodiments wherein the verification of the mDL authenticity indicates that the recipient mDL is inauthentic (e.g., due to a corrupted mDL), operation 312 may failover to a traditional rental asset provision process.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable efficient provision of a rental asset to a rental candidate. Example embodiments thus provide tools that overcome the problems faced by conventional rental asset provision mechanisms and techniques. By avoiding the use of conventional rental asset provision mechanisms and techniques, example embodiments thus save time and resources, while also eliminating the need for manual verification and authentication of rental candidates. Moreover, embodiments described herein counter a wide range of emerging risks in an evolving technological landscape. Finally, by automating functionality that has historically required human analysis, the speed and consistency of rental asset provision performed by example embodiments unlocks many potential new functions that have historically not been available, such as the ability to conduct identity verification of a rental candidate and secure a rental asset with a rental access key generated in near-real-time.

For instance, by utilizing mDLs to authenticate rental candidates for a rental event, example embodiments provide protection against the loss, theft, and/or misuse of rental candidate information shared with rental entities during conventional rental events. As such, by streamlining and automating the rental asset provision process for a rental event, resources and material costs are significantly lowered for rental entities. Example embodiments also reduce the technical complexity of requiring manual verification and authentication of rental candidates. As such, example embodiments provide additional layers of security to ensure the accurate and efficient evaluation of rental candidates for a particular rental event.

Moreover, example embodiments contemplated herein provide technical solutions that solve real-world problems faced by rental entities who wish to safely provide rental candidates with access to a rental asset by employing various mDL-based authentication techniques. While confirming the identity of a rental candidate has been a technical challenge for several years, the sophistication of identity fraud and impersonation techniques have made this problem significantly more acute. By utilizing a legally issued mDL to authenticate the identity of a rental candidate and providing a rental candidate with access to the rental asset via a rental access key generated in near-real-time, embodiments of the present disclosure ensure that rental candidates are properly verified and/or authenticated for a particular rental event, thereby increasing the security and safety of the rental asset provision process for both a rental candidate and a rental entity.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing a rental candidate with access to a rental asset, the method comprising:
receiving, by communications hardware and from a candidate device, a rental initiation request comprising (a) an indication of the rental asset, (b) an indication of a mobile driver's license (mDL) associated with the rental candidate, and (c) rental candidate information;
authenticating, by authentication circuitry and based on the mDL, the rental candidate;
in response to authenticating the rental candidate, determining, by rental management circuitry and using a risk determination model, a risk level indicative of an inferred risk associated with renting the rental asset to the rental candidate;
in response to the risk level satisfying a rental requirement, generating, by the rental management circuitry and based on the rental candidate information, a rental access key configured to enable use of the rental asset; and
providing, by the communications hardware, the rental access key to the candidate device.

2. The method of claim 1, wherein the rental candidate information comprises a payment account associated with the rental candidate.

3. The method of claim 1, wherein authenticating the rental candidate further comprises:
providing, by the communications hardware, an mDL authentication request to an issuing authority (IA) system associated with an IA that provisioned the mDL to the rental candidate, wherein the mDL authentication request comprises the mDL;
receiving, by the communications hardware, a mDL validity response from the IA system, wherein the mDL validity response is indicative of whether the mDL was verified; and
authenticating, by the authentication circuitry, the rental candidate based on the mDL validity response.

4. The method of claim 1, further comprising determining, by the authentication circuitry, that the candidate device is associated with the rental candidate and that the rental candidate is in control of the candidate device.

5. The method of claim 1, wherein determining the risk level further comprises:
selecting, by the rental management circuitry, a risk assessment type based on the rental asset, wherein the risk assessment type is associated with at least one rental requirement;
generating, by the rental management circuitry and using the risk determination model, a risk score, wherein the risk score is generated based on a comparison between the rental requirement and the rental candidate information; and
determining, by the rental management circuitry and using the risk determination model, the risk level based on the risk score.

6. The method of claim 1, further comprising:
receiving, by the rental management circuitry and from the candidate device, an indication of a secondary rental candidate and secondary rental candidate information; and
generating, by the rental management circuitry and based on the secondary rental candidate information, a secondary rental access key, wherein the secondary rental access key is configured to enable use of the rental asset for the secondary rental candidate.

7. The method of claim 6, further comprising providing, by the communications hardware, the secondary rental access key to a secondary candidate device.

8. The method of claim 6, wherein the secondary rental access key is configured to enable use of the rental asset for the secondary rental candidate based on access limitations dictated by the rental candidate.

9. An apparatus for providing a rental candidate with access to a rental asset, the apparatus comprising:
communications hardware configured to:
receive, from a candidate device, a rental initiation request comprising (a) an indication of the rental asset, (b) an indication of a mobile driver's license (mDL) associated with the rental candidate, and (c) rental candidate information;
authentication circuitry configured to:
authenticate, based on the mDL, the rental candidate;
rental management circuitry configured to:
in response to authenticating the rental candidate, determine, using a risk determination model, a risk level indicative of an inferred risk associated with renting the rental asset to the rental candidate, and
in response to the risk level satisfying a rental requirement, generate, a rental access key configured to enable use of the rental asset,
wherein the communications hardware is further configured to:
provide the rental access key to the candidate device.

10. The apparatus of claim 9, wherein the communications hardware is further configured to:
provide an mDL authentication request to an issuing authority (IA) system associated with an IA that provisioned the mDL to the rental candidate, wherein the mDL authentication request comprises the mDL; and
receive a mDL validity response from the IA system, wherein the mDL validity response is indicative of whether the mDL was verified,
wherein the authentication circuitry is further configured to:
authenticate the rental candidate based on the mDL validity response.

11. The apparatus of claim 9, wherein the authentication circuitry is further configured to determine that the candidate device is associated with the rental candidate and that the rental candidate is in control of the candidate device.

12. The apparatus of claim 9, wherein the rental management circuitry is further configured to:
select a risk assessment type based on the rental asset, wherein the risk assessment type is associated with at least one rental requirement;
generate, using the risk determination model, a risk score, wherein the risk score is generated based on a comparison between the at least one rental requirement and the rental candidate information; and
determine, using the risk determination model, the risk level based on the risk score.

13. The apparatus of claim 9, wherein the rental management circuitry is further configured to:
receive, from the candidate device, an indication of a secondary rental candidate and secondary rental candidate information; and
generate, based on the secondary rental candidate information, a secondary rental access key, wherein the secondary rental access key is configured to enable use of the rental asset for the secondary rental candidate.

14. The apparatus of claim 13, wherein the communications hardware is further configured to provide the secondary rental access key to a secondary candidate device.

15. A computer program product for providing a rental candidate with access to a rental asset, the computer program product comprising at least one non-transitory computer readable storage medium storing software instructions that, when executed, cause an apparatus to:
receive, from a candidate device, a rental initiation request comprising (a) an indication of the rental asset, (b) an indication of a mobile driver's license (mDL) associated with the rental candidate, and (c) rental candidate information;
authenticate, based on the mDL, the rental candidate;
in response to authenticating the rental candidate, determine, using a risk determination model, a risk level indicative of an inferred risk associated with renting the rental asset to the rental candidate;
in response to the risk level satisfying a rental requirement, generate, a rental access key configured to enable use of the rental asset; and
provide the rental access key to the candidate device.

16. The computer program product of claim 15, wherein the software instructions, when executed, further cause the apparatus to:
provide an mDL authentication request to an issuing authority (IA) system associated with an IA that provisioned the mDL to the rental candidate, wherein the mDL authentication request comprises the mDL;
receive a mDL validity response from the IA system, wherein the mDL validity response is indicative of whether the mDL was verified; and
authenticate the rental candidate based on the mDL validity response.

17. The computer program product of claim 15, wherein the software instructions, when executed, further cause the apparatus to determine that the candidate device is associated with the rental candidate and that the rental candidate is in control of the candidate device.

18. The computer program product of claim 15, wherein the software instructions, when executed, further cause the apparatus to:
select a risk assessment type based on the rental asset, wherein the risk assessment type is associated with at least one rental requirement;
generate, using the risk determination model, a risk score, wherein the risk score is generated based on a comparison between the rental requirement and the rental candidate information; and
determine, using the risk determination model, the risk level based on the risk score.

19. The computer program product of claim 15, wherein the software instructions, when executed, further cause the apparatus to:
receive, from the candidate device, an indication of a secondary rental candidate and secondary rental candidate information; and
generate, based on the secondary rental candidate information, a secondary rental access key, wherein the secondary rental access key is configured to enable use of the rental asset for the secondary rental candidate.

20. The computer program product of claim 19, wherein the software instructions, when executed, further cause the apparatus to provide the secondary rental access key to a secondary candidate device.
